(19) United States
(12) Patent Application Publication
(10) Pub. No.: US 2014/0079480 A1
(43) Pub. Date: Mar. 20, 2014

(54) PLUG

(71) Applicant: Jaap Van Der Kamp, Westzaan (NL)

(72) Inventor: Jaap Van Der Kamp, Westzaan (NL)

(73) Assignee: URPLUG B.V., AUID-SCHARWOUDE (NL)

(21) Appl. No.: 14/112,982

(22) PCT Filed: Apr. 18, 2012
(86) PCT No.: PCT/NL12/00028

§ 371 Date: Dec. 5, 2013

(30) Foreign Application Priority Data
Apr. 19, 2011 (NL) 1038761

(51) Int. Cl. F16B 13/12; F16B 21/10; F16B 39/34; F16B 13/14

(52) U.S. Cl. CPC F16B 13/12; F16B 13/14; F16B 21/10; F16B 39/34
USPC 403/374.1

(57) ABSTRACT

A plug to fix a nail, screw or other device in a bore has the advantage over classical plugs that the bore is allowed to be narrow, only slightly wider than the screw. The plug is almost universal in respect to bore size and sizes of inserted devices. Characteristic is the construction, giving an optimum between maximum capability of compressing the plug versus a strong counter pressure against the lateral force exerted by the nail or screw. Characteristic for the material used is that, depending on the construction, the elasticity is restricted between discrete values and the yield strength must be sufficient high. Attention is paid to the following features: plug design to deal with a range of standard sizes of stone drills c.q. bore sizes; plug design to place several plugs optimally next to each other in one bore; a plug being a container for glue giving initial fixation.

The invention applies to a plug to keep a nail, screw, bolt or dowel fixed in a bore. Characteristic is that the clamping function of the plug is realized by a construction based on one or more arches, protrusions and/or cells in combination with a certain elasticity and a sufficient yield strength of the material. The construction gives an optimum between a maximal capability of compressing the plug versus a strong counter pressure from the plug against the lateral force exerted by the inserted device, all this with the objective to get one universally applicable plug.

The elasticity and yield strength also are important parameters for the capability to clamp a nail.

### New Features

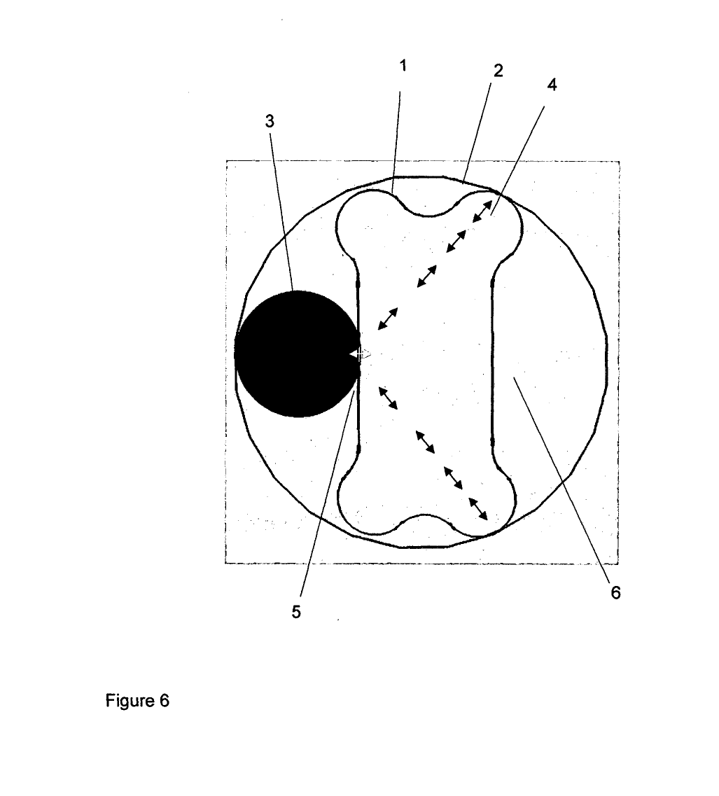

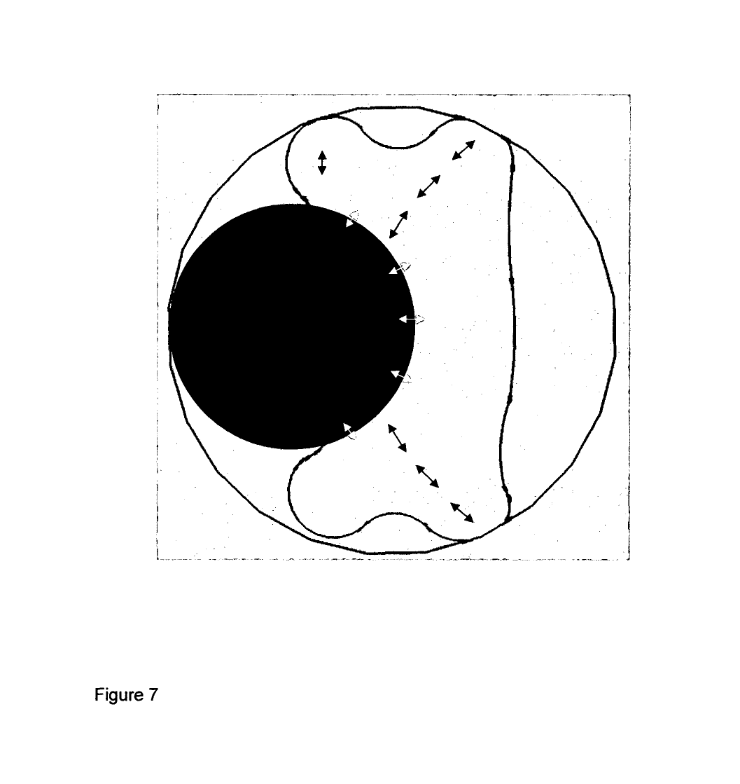

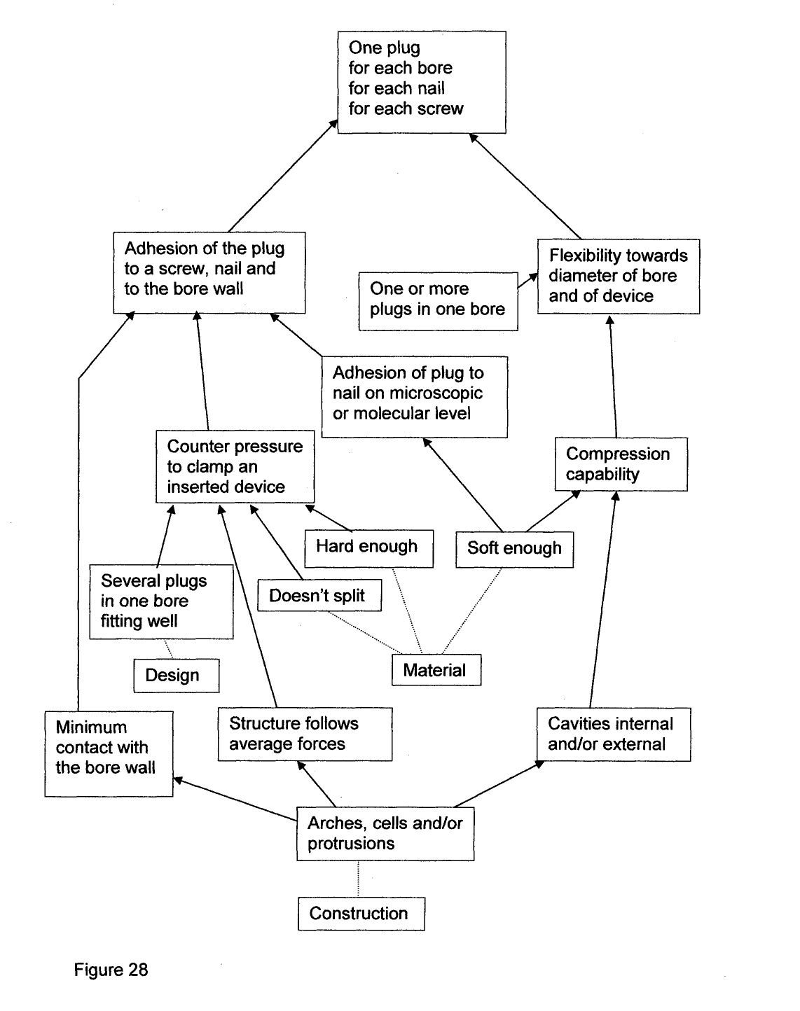

New Features are:
The construction, based on one or more arches, protrusions and/or cells, yielding an optimum between the capability of compressing the plug to create space for the inserted device versus a strong counter pressure from the plug against the lateral force exerted by the nail or screw. The compression capability is realized by cavities inside and/or around the plug created by the said arches, protrusions and/or cells. The capability of compressing the plug results in a high flexibility towards the diameter of the nail or screw for a given bore diameter and a given plug size. For example when the bore has a diameter of 3 mm and the plug can be compressed strongly, a nail with a diameter of 1,5 mm can be fixed with a given plug, but also a nail with a diameter of 2,5 mm can be fixed using that same plug, compressing the plug stronger. Such a strong compression would not be possible when the plug would be massive without arches, protrusions or cells, lacking cavities inside and outside. Such a massive plug would prevent the 2,5 mm nail from penetrating the bore because the bore would contain too much plug material to give space to the nail. Whereas classical plug constructions are aimed on a maximum fixation power, the new plug described here is aimed on an optimal flexibility in respect to the diameter of the inserted device and the bore, maintaining a sufficient fixation power. For a scheme of the relationships between the different plug features, see FIG. 28. Comparison with existing plugs: Existing plug designs lack a special structure and choice of material intended to reach the said optimum between a maximal capability of compressing the plug versus a strong counter pressure from the plug against the lateral force exerted by the inserted device. An example of an existing plug design using a deformable material to clamp a device in a bore is WO 2008/107886 A2 ‘Self drilling bolt with anchor’ (page 8, line 25 thru page 9 line 3). This self drilling bolt however lacks the said construction of arches, cells and/or protrusions and is not build for flexibility in bore diameters.
The material: An option is to make the said plug of twisted fibrous material like aramid fiber, glass fiber or carbon fiber. A certain percentage of the material will consist of resin, the plug consisting of for instance 70% fiber material and 30% resin. To prevent the fibers being split under pressure, the fibers must be twisted, must not be unidirectional. Comparison with existing plugs: An existing patent using fibers is Rawlings' plug U.S. Pat. No. 1,059,209 ‘Wall and like plug or socket’ from a century ago. But in Rawlings' patent the fibers are placed longitudinally, not twisted (first page of the description, line 30). A simple rod of twisted aramid fiber would destroy against the novelty of this new feature, but because of the fact that the plug has the said construction of arches, cells and/or protrusions this is not true.
A hollow, in cross section, where the inserted device can ‘land’ on a plug with the said construction of arches, cells and/or protrusions. The hollow applies on situation where the inserted device is placed next to the plug instead of centric in the middle of the plug. In many designs this will be on top of an arch. See for instance the hollow indicated with ‘1’ in FIG. 9. Also in many of the other given designs in which the device is placed next to the plug this hollow is present, although less explicit. In this way, the long and shallow side of the ‘bone’ design of FIG. 6 is also seen as a hollow. Because this plug design is bilaterally symmetrical, there are two potential ‘landing places’ in this design, indicated by the arrows 5 and 6. Comparison with existing plugs: In literature and in practice I did not find eccentric plugs with a hollow to let land the inserted device.
The design: The plug, or a combination of plugs in one bore, is optimally fit to deal with a range of the standard sizes of stone drills c.q. bore sizes. See FIG. 4 for an example. The most common stone drills in DIY (do it yourself) stores are 4 mm, 5 mm, 6 mm etc. in a set. Sometimes a set starts with a 3 mm drill. A 3 mm stone drill sold as single drill is rare. For these reasons, and also because using plugs for fixing nails is a new field of interest and nails don't need wide bores, the plug design given in FIG. 4 is based on bore sizes of 3 mm increasing stepwise with 1 mm. The dimensions of the plugs in FIG. 4 are given in FIG. 3. The most obvious plug combination will be a combination of identical plugs in one bore, but also a combination of different kinds of plugs is possible. Comparison with existing plugs: A classical plug is designed for only one bore c.q. drill size, not for combinations of plugs to deal with a range of common drill sizes.
The design: A plug which is designed to place several plugs next to each other in one bore and at the same time leaving some space in between and resulting in a solid basis for small devices in a wide bore. This design feature is shown in FIG. 4. The result of the space between the plugs is that the user has the possibility to choose an optimal position to insert the nail or screw. This position can be next to the wall of the bore but also in the centre of the bore. See FIG. 27, where the black dots indicate a variety of positions where the user can choose the device being inserted. When there would be no space left between the plugs, it would be difficult to sting the nail or screw just in the position where it is wanted, e.g. just in the centre of the bore. Comparison with existing plugs: Classical plugs do not have this feature, although simple rods being rectangular in cross section also fit nice next to each other what results in a stable plug combination. The difference between rectangular rods and the said design is that a plug with the said design leaves some space between the plugs in a way that optimal positions for insertion are created. Simple rods not being rectangular leave space between the plugs, but lack the feature of a stable plug combination.
The composition: An option is to fill a plug to clamp common nails, screws and dowels with glue. The added value of the plug is that it gives initial fixation, which is useful to earn time to let harden the glue. The glue can be a one-component or a more-component glue. In case of a more-component glue the components are separated in different compartments of the plug or in different plugs. The solid part of the plug provides initial clamping and provides also a reservoir to store the glue. For instance the cavities of the plugs in FIGS. 20, 21, 22 and 26 could be filled with glue. Comparison with existing plugs: Existing patents describing a situation in which glue is used, are EP 1 176 180 A1 ‘Viscous and amine-cured chemical anchoring adhesive’ (for a combination with aluminium see alinea 0036), CA 897 439 A ‘Resin anchored reinforced structures’ (for a combination with aluminium see page 8 line 7), GB2025557 ‘Adhesive anchoring of bolts, etc.’ and DE9319179, ‘Klebepatrone, insbesondere zum Einkleben von Ankerstangen’. The difference with the plug described in the underlying document is the combination:
   1. that the new plug is intended primarily to fix common nails, screws and dowels instead of especially designed bolts, and
   2. that the non-glue material of the plug being the container for the glue realizes an instant fixation of the inserted device, not being only a container for the glue.
   3. That the new plug is simple, being a plug consisting of one kind of material (or a composed material such as fibers and resin) plus the glue.
A combination: New is a combination of two plugs each filled with one component of a two-component glue. The two plugs each having one of the two adhesive components are used together in one bore. During insertion the containers for the adhesive, being the solid part of the plugs, break open releasing the adhesive, which will mix and cure thereafter. Obvious is to make the container so that it can be used for initial clamping.
The application: New is that the plug gives a strong fixation of common, smooth nails.
The application: New is that one plug size is sufficient to deal with a large variety of bore sizes. This is because of the capability to compress the plug and because several plugs can be placed next to each other (and behind each other) in one bore. So you only need one plug size for many situations.
The application: For the same reason (capability to compress the plug and because several plugs can be placed next to each other) the plug is developed to deal with a wide range of nail and screw diameters.
The application: The plug also is universal because it is applicable to different devices: nails, screws, to fix dowels in a bore that is too wide and it is applicable in other situations where some improvisation is needed.
The application: New in the do-it-yourself domain is that the plug can be so tiny that only a small bore is needed, the bore being only slightly wider than the diameter of the nail or screw. For many cases a stone drill diameter of 3 mm will be sufficient using the new plug. This 3 mm size is hardly used until now.

Application

The Plug is Applicable to:

1. Nails, screws and comparable items which are intended to be fixed in a bore.
2. Bores in all kinds of material which can stand some pressure such as concrete, brick, soft kinds of stone, gypsum walls and wood.
3. Bores in all common sizes in the do-it-yourself domain.
4. All situations in which there is a demand for a small device (the plug) to clamp something.
4. Use at home, in industry, surgery, building, shops, et cetera. The plug described here is primarily intended for use at home. For professional use the plug can be useful in refurbishing buildings and in general and technical services.

Material

The plug can be made of (alloys of or composites of) aluminium, carbon fiber, glass fiber, aramid fiber, vegetable fibers, copper, gold and other materials with a comparable elasticity, i.e. a comparable Young's modulus and a comparable yield strength. The said fibers are embedded in a matrix like resin. ZAMAK is a good candidate, being an alloy of zinc, aluminium, magnesium and copper. The said materials must have a good Young's modulus (not too few, not too much) and a sufficient yield strength to realize an optimum between a maximal constructive force and a maximal capability of the plug to be compressed. To clamp the common kind of (smooth) nails the plug material also must have a good Young's modulus (not too few, not too much) and a sufficient yield strength. In the next paragraph ‘Material properties, construction and design’ will be shown why no exact ranges can be given for the Young's modulus and the yield strength.

In wet situations aluminium is less convenient. The aluminium will act as an anode and dissolve in the water after a long period of time. Thus the aluminium plug will disappear. In such situations another material such as glass fiber will be preferred.

In situations in which a non-reactive plug is needed such as in surgery, the plug can be made of a non-reactive metal like (an alloy of) gold or a non-metal.

An advantage of a metal like aluminium or copper is that the plug can be deformed by the user to be suited for specific needs. For instance the plug can be deformed to the shape of a dowel pin by compressing one end.

The given material names, e.g. ‘aluminium’, mean: ‘aluminium or an alloy or composite with aluminium as predominant material’.

Material Properties, Construction and Design

This paragraph describes material variables, construction variables, design variables and some relations between them. Because the relationships between material, construction and design features are rather complex, FIG. 28 is given, where causal relationships between properties are indicated by arrows. Dotted lines indicate to which quality (e.g. construction, or material) the property belongs.

Material—elasticity and yield strength: The plug material must have a certain elasticity, not too much and not too few and a sufficient yield strength. In having too much elasticity (a low Young's modulus) or a yield strength which is too low, the plug material would give too few counter pressure to a nail to clamp it. This is the case with nylon and lead. Now the opposite part of the spectrum: Having too few elasticity (a high Young's modulus) and a yield strength which is too high, the material is too hard for the plug to be compressed and to allow the screw or nail make space for itself in the bore. An additional effect in using a nail is that plug material which is too stiff will not give a good adhesion to the nail. Also in using a screw a certain softness of the material is necessary so that the screw thread can bite itself into the material. An example in which the plug is too hard is a massive plug made of steel. Nevertheless, if a plug which normally would be too hard would have a fine cellular structure in cross section, then the said disadvantage of the hardness could be compensated by this cellular structure. Thus the hardness of the plug as a whole is a result of the hardness of the material and the structure and design of the plug. Therefore no exact upper boundary value can be given for the Young's modulus and the yield strength of the plug material. Also for the lowest possible value for the Young's modulus and the yield strength of the plug material no exact lower boundary value can be given because also in this case the elasticity and yield strength of the plug as a whole is not only dependent on the material but also depends on the plug design.

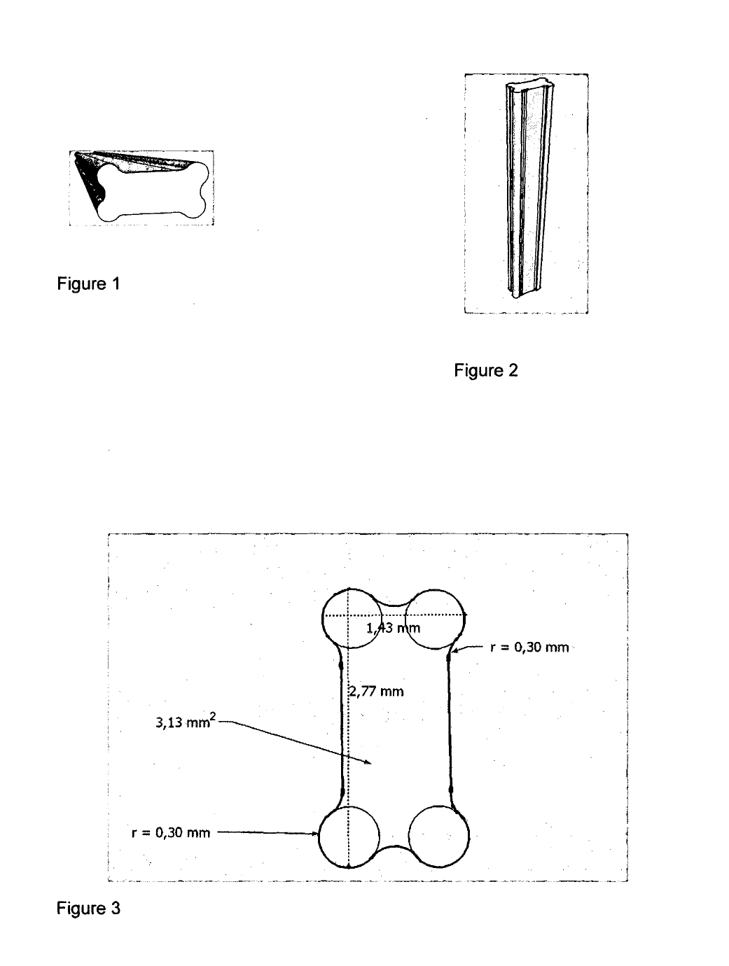

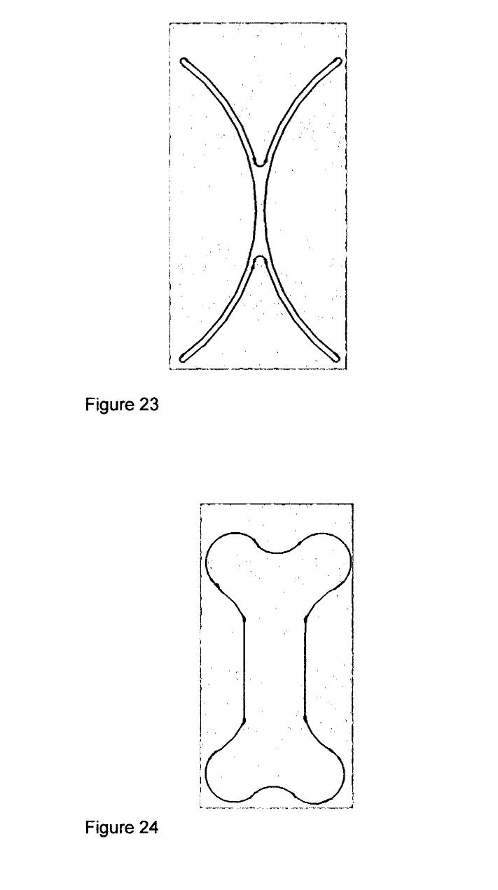

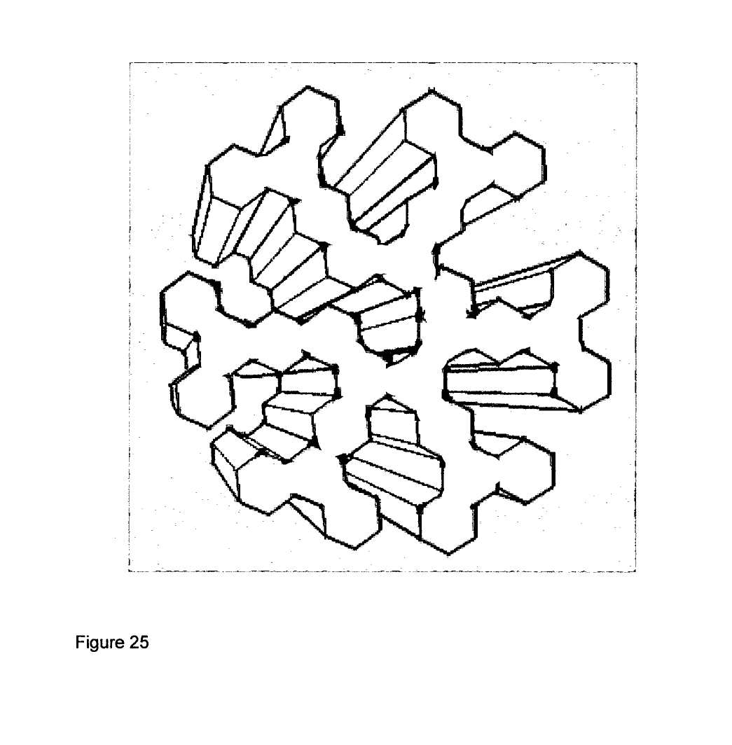

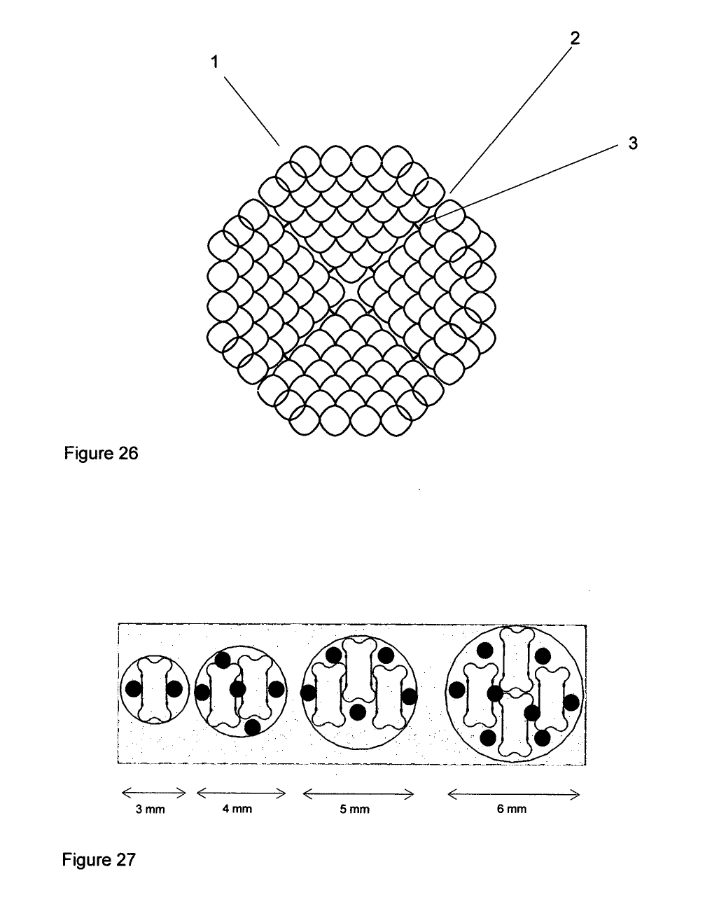

Construction—amount of cavities (inside and/or outside the plug): When the plug has too much material in respect to the amount of cavities inside the plug or between protrusions, the plug gives too few possibility of compressing the plug to give space to the nail or screw inserted. In a formula, thinking in a simplified cross sectional 2D model: The maximum area covered by an inserted device is the area of the bore minus the area covered by the compressed plug material. The ideal plug consists of almost no plug material, giving maximum space to the inserted device. See FIGS. 23 and 26. FIG. 24 gives a design with a thickness between the designs of FIGS. 23 and 1.

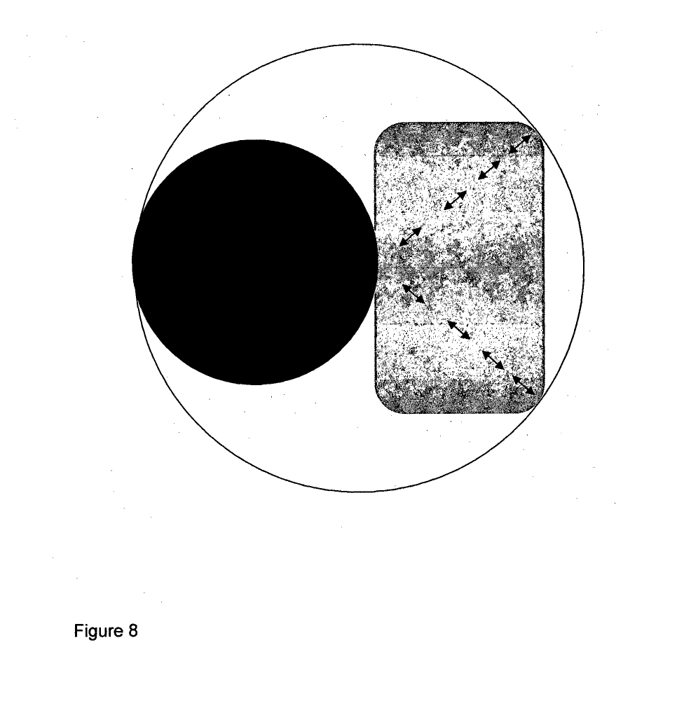

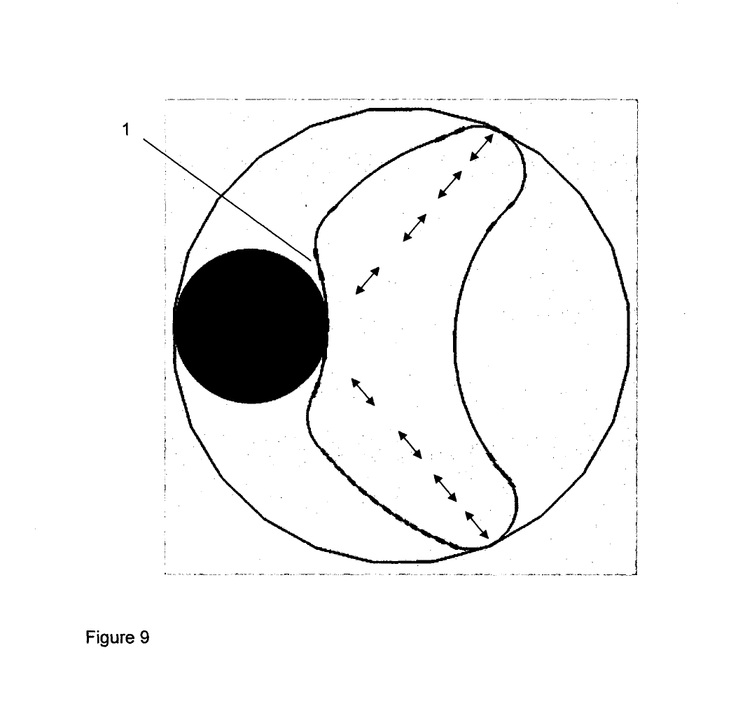

Construction—arch: The arch is a classical solution to give a maximum strength using a minimum of material in a situation where forces come from different directions around the arch. In plug perspective the arch is a optimal solution to give a maximum amount of cavities combined with a maximum counter pressure from the plug to the inserted device. See FIGS. 6, 7, 8. 9 and 14 for examples of arch constructions in which the average forces between the inserted device and the bore wall are indicated by double-headed arrows. An arch has two ‘feet’. From plug perspective the two feet stand on the wall of the bore. The top part of the arch receives its pressure from the inserted device. As soon as the device touches the plug, the force from the device to the plug acts on one point and the average forces form a triangle, shown in FIGS. 6, 8 and 9. When the device is inserted further, forces on the plug come from different directions around the plug and the average forces take the form of a bended arch. See FIGS. 7 and 14. To deal with both a triangular arch and a bended arch the plug must have some kind of bended arch structure. Even in a simple rod an arch can be discerned because the rod is placed in a bore with a round shape, see FIG. 8. The simple rod however lacks the capability to compress much and is therefore not an optimal design for a plug which is meant to be as much as possible universally applicable. Arches can be combined, as seen in the 3D FIG. 25 where a snowflake structure is built up from two layers of arches.

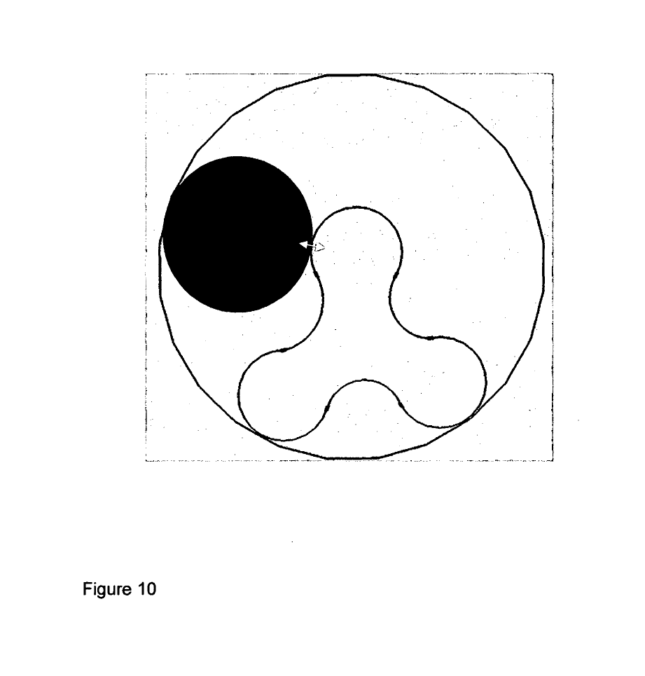

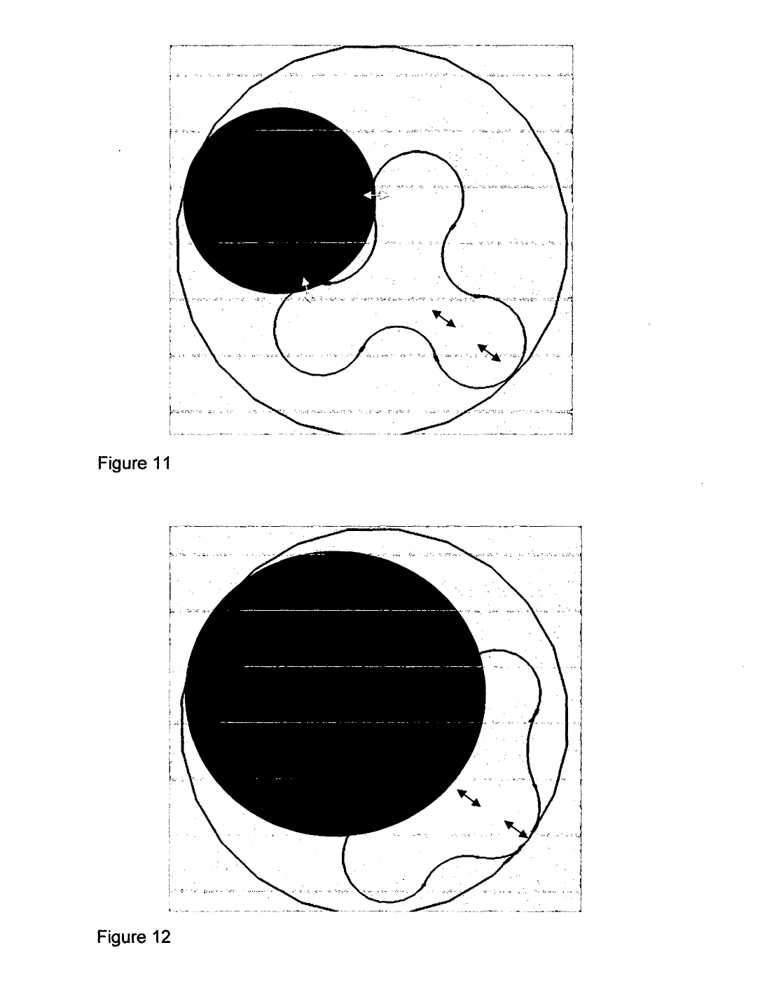

Construction—protrusions: Especially in star shaped plugs with an odd number of protrusions, it will occur that there are initially no two ‘feet’ making contact with the wall of the bore, but only one protrusion making contact. This one protrusion will be the first part of the plug to collapse, giving flexibility and, indirectly, counter pressure to the inserted device. In a later phase of compression the arch construction will do its work. See FIGS. 10, 11 and 12. Construction—cells: A combination of arches can result in a cellular structure, which is clearly seen in FIG. 26. This construction, in cross section, consists of many parabolas build upon each other, yielding a cellular structure. In three dimensions, each cell corresponds with a tube. In this construction parabolas have been chosen instead of triangles because parabolas is the centre of the plug will collapse first, what results in forces coming from different directions upon the parabolas further away from the centre of the plug. Not only arch based cell structures give strength, also cell constructions as found in honeycombs and wood (cross section) give maximal strength with a minimum of material and are therefore suitable for a good plug design. Arches, cells and protrusions cannot be discerned clearly because an arch can be seen as two protrusions and a cellular structure can be seen as a combination of arches. A combination of cells, arches and protrusions is shown in FIG. 22.

Construction—an arch acting like a spring: FIG. 20 shows four identical arches, with three different functions. The arch making contact with the inserted device acts as the just mentioned hollow to let ‘land’ the device on the plug. The arch making contact with the wall of the bore acts as the mentioned arch to give a maximum strength using a minimum of material. The two lateral arches, in combination with the cavity in the middle part of the plug, act as a suspension system giving more capability to the plug to be compressed. Thus this figure shows three functions of the arch.

Internal construction of the material itself—fibers: When using fibers like glass, carbon or aramid fibers combined with resin (for instance 70% fiber with 30% resin), the fibers must not be situated unidirectional but must be twisted. Plugs with unidirectional fibers will split easily when a nail exerts its force on it, resulting in a lack of counter pressure against the inserted device. So when fiber material is used in plugs, the fibers must be twisted.

Construction—hollow: A hollow, in cross section, where the inserted device can ‘land’ on the plug. In many designs this will be on top of an arch. See for a clear example FIG. 9, where the hollow is indicated by arrow 1. Also in all the other given designs in which the device is placed next to the plug—except for the simple rod of FIG. 8—this hollow is present.

Construction—the end parts of the plug: When the production process is based on extrusion or pulltrusion (e.g. in the case of glass fiber or aramid) attention must be paid to the way in which the plugs are separated from the extrusion or pulltrusion profile. A result of cutting can be that the ends of the plug are deformed and will therefore have another shape in cross section than the middle part of the plug. This can make the plug work suboptimal in respect to the capability to insert in a narrow bore and in the capability to insert more than one plugs in one bore. In the contrary, those distortions in the end part of the plug can also have positive effects, visually in clamping more than one plugs together in the bore before inserting the device. The plugs will not fall easily out of a bore in the ceiling. Interesting in this respect are the fluffy end parts of aramid plugs as a result of cutting the tough fibers.

Design—size: the size of the plug must match the common drill/bore sizes.

Construction/design—shape: when using more than one plug in one bore the shape of the plug is an important feature determining the stability of the combination of plugs (this is favorable to a high clamping force in as many as possible situations) and determining the amount of cavities between the plugs (this increases the capability to compress the plug combination). The shape also determines whether or not there is left some space between the combined plugs, which determines the amount of freedom which the user has to choose a position to insert the device. See FIG. 27. Each black dot indicates a position to insert a device.

Design—symmetry: A symmetric plug gives a maximum ease of use. When a plug is not symmetrical, the user has to think about the position of the plug compared to the nail or screw, what is less user-friendly.

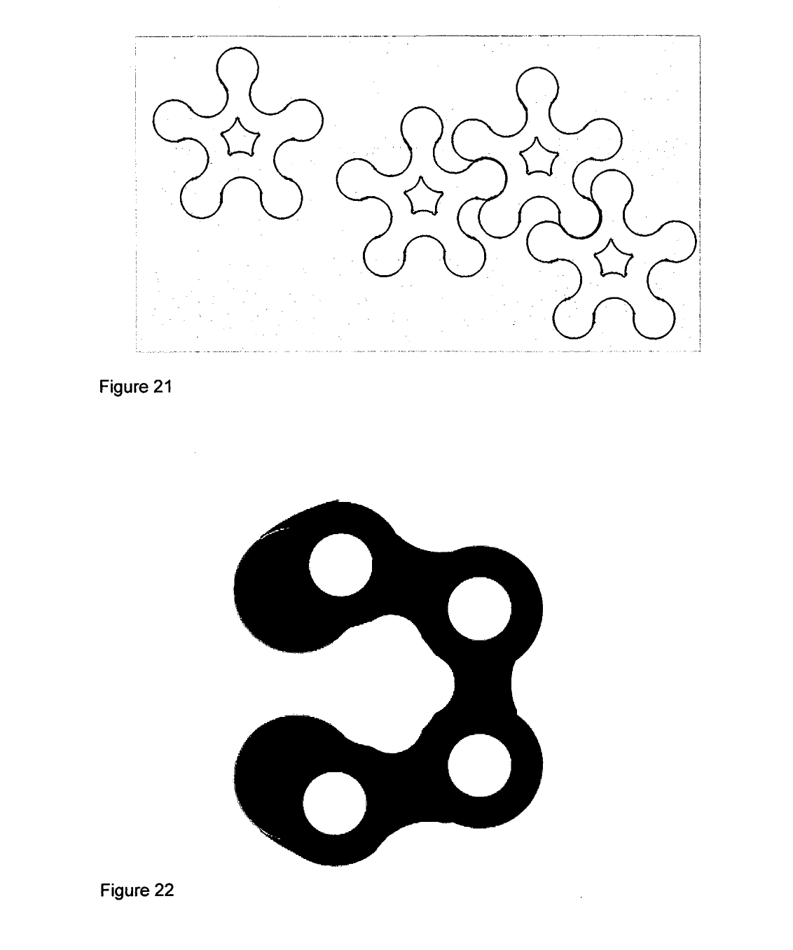

Design—clasp: An optional design/construction feature is that more than one plugs in one bore can stick in each other. A protrusion of one plug clasps in a hollow of another one. Combining several plugs to one before inserting into the bore could be user-friendly. See FIG. 21.

Construction/design—the possibility to fix a plug on the device prior to insertion: The plug can be designed in a way that the nail or screw can be placed centrally in the plug. Although the advantages of the plug concept described in this document are most prominent in a plug with the inserted device placed next to a plug, the advantage of placing the device centrally in the plug is that the plug can be placed on top of the device prior to insertion of the plug-device combination. This is convenient when a fast fixation is needed or when plugs are sold pre-mounted on the devices.

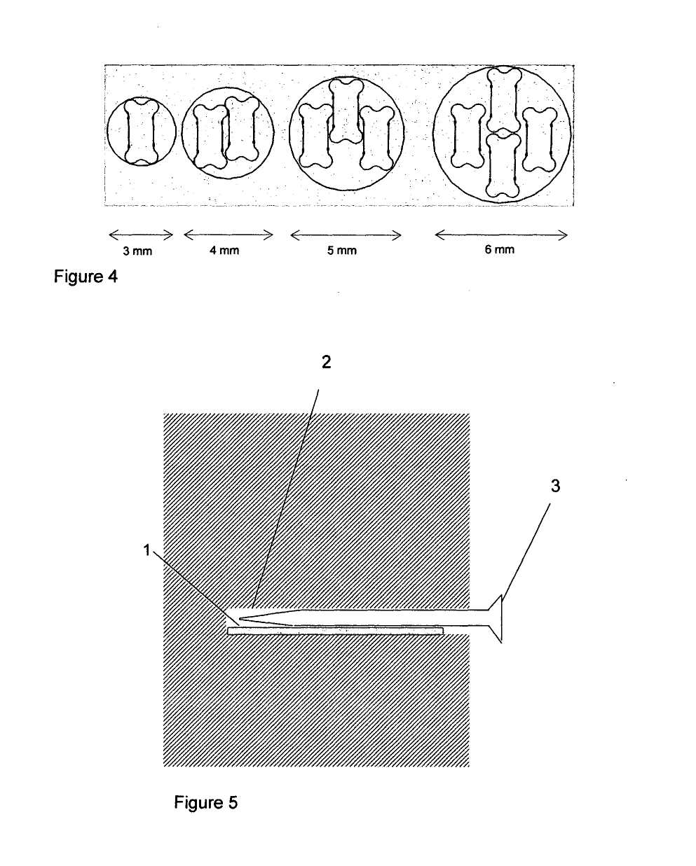

Construction/design—role or strip: It is possible to deliver the plug on a role, whereby the user can break or cut a piece to get a plug of the desired length. This concept has been described in EP 1 176 180 A1, FIG. 2. Also it is possible to deliver the plug in straight rods with predefined breaking points, for instance on each centimeter. A plug of the desired length is made by breaking a piece from the rod in the desired length.

Construction—An option is to have the two ends, or one end, of the plug tapered. The value of this is that a device can be inserted easier next to a plug. For the same reason in centric plugs the end(s) can be provided with a funnel-shaped hollow to guide the inserted device to the centre of the plug. Another value of a tapered end in combination with a corresponding hollow at the other end, is that plugs can be placed well behind each other in one bore.

Shape

An endless variation of shapes is possible, based on one or more arches, protrusions and/or cells.

FIGS. 1, 2, 3, 4 and 6, 7, 24 and 27 give a bone-like shape, corresponding with one arch for a given nail situated at one long side of the plug. The plug has a bilateral symmetry; two arches are possible.

FIG. 9 gives a single arch.

FIGS. 10, 11 and 12 show a plug with three protrusions in different stages of compression, the big black dot representing an inserted nail in different phases of insertion.

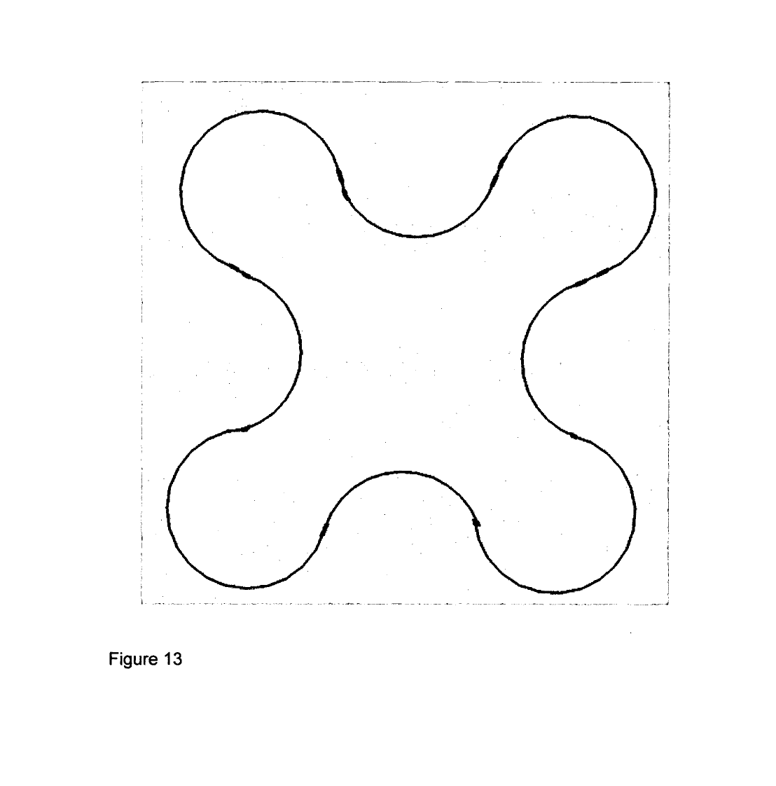

FIGS. 13 and 14 give a plug with four extrusions. Four arches are possible. When a nail or screw is inserted, only one arch is operational.

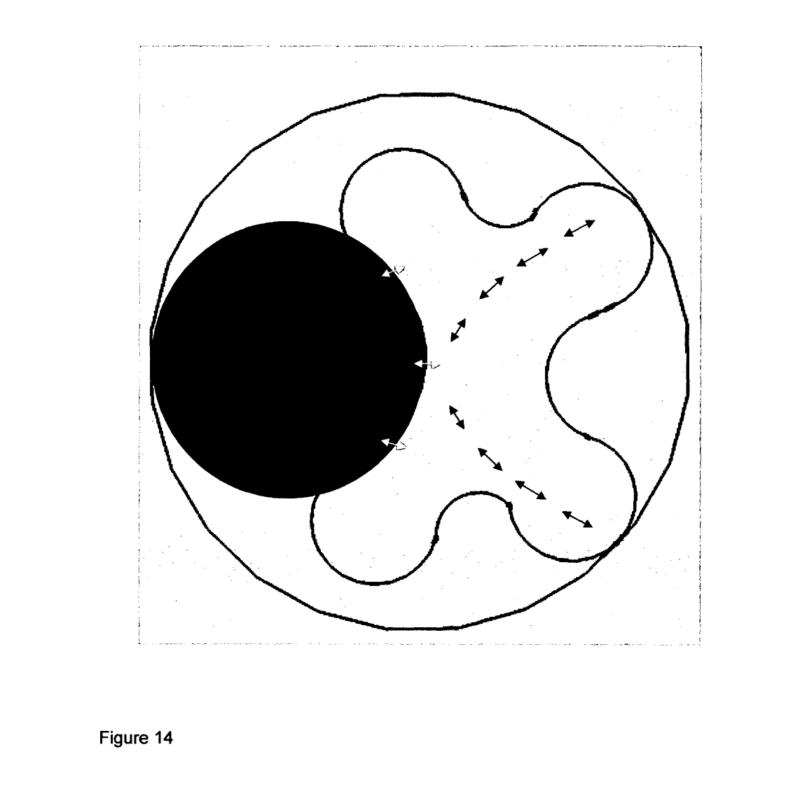

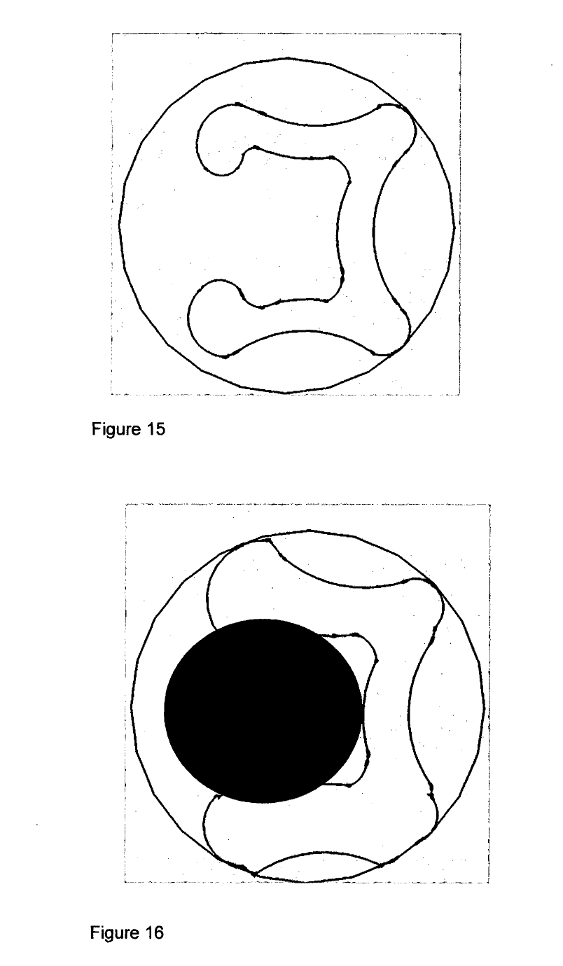

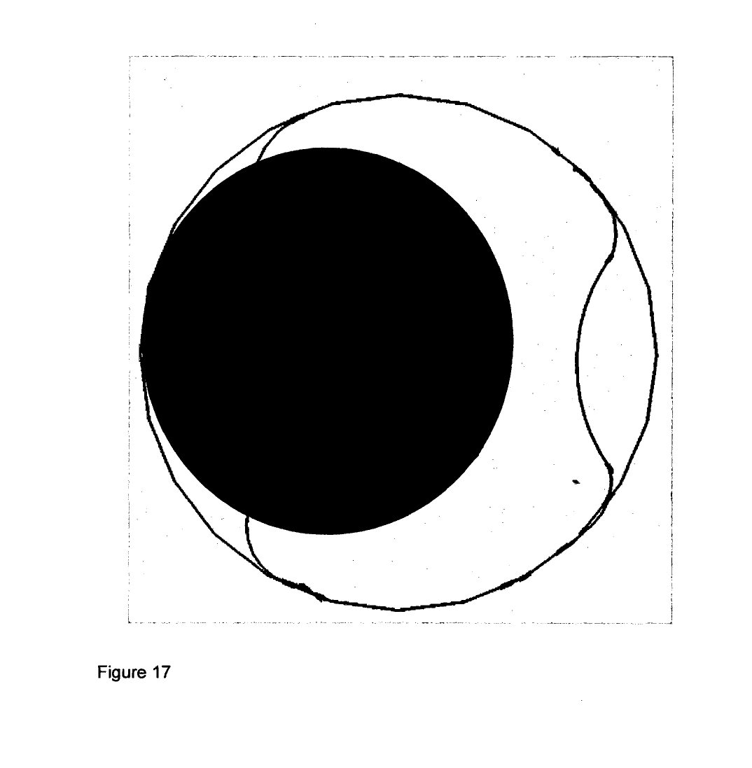

FIGS. 15, 16 and 17 give a centric plug with four corners. The plug has one open side giving an easily expansion of the plug so that the arches in the plug construction can do their work. Without the open side the arches would be deformed and there would be no clamping when the inserted nail would be as thick as shown in FIG. 16. Instead of being used as a centric plug the centric plugs given in this document also can be used as eccentric plugs, placing the inserted device next to the plug instead of in the middle.

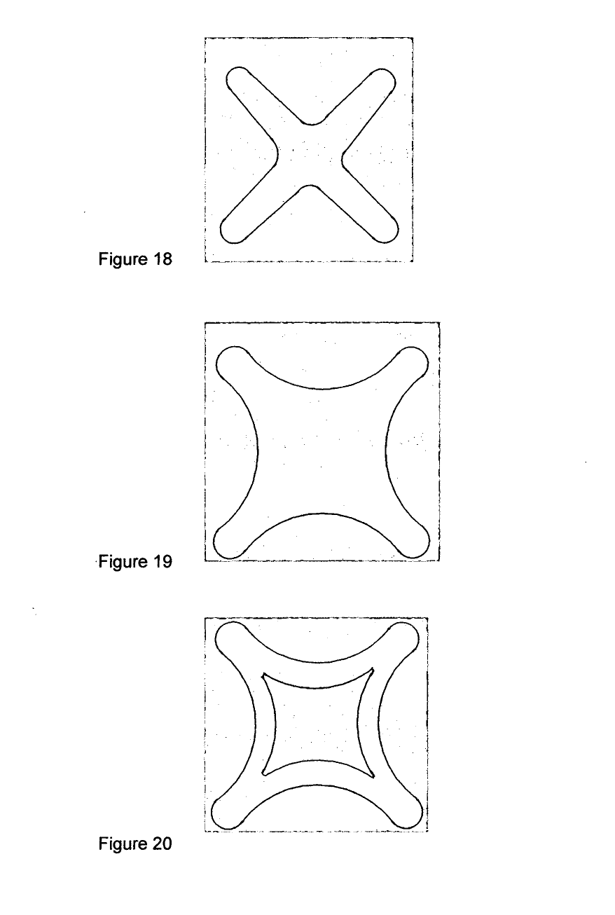

FIG. 18 shows a plug with four extrusions, being slimmer than the plug of FIGS. 13 and 14. By being slimmer this plug has more capability to be compressed. To give a similar counter pressure against the inserted device, it must be made of a material with a higher Young's modulus and/or a higher yield strength.

FIG. 19 shows the plug of FIG. 18 but with stronger arches. The difference between the plug of FIG. 19 and the one of FIGS. 13 and 14 is that FIG. 19 focuses on individual clamping force of one plug whereas FIGS. 13 and 14 focus on plugs fitting nice together so that the combination of plugs will give a strong clamping force.

FIG. 20 shows the plug of FIG. 19 provided with a cavity by which more compression capability is realized.

FIG. 21 shows star shaped plugs fitting well, even clasping, into each other.

FIG. 22 shows a centric plug provided with cavities and one open side to let the plug expand.

FIGS. 23 and 24 give slimmer versions of the bone shaped plug of FIG. 1, where the plug of FIG. 23 is most capable of being compressed. To give a sufficient counter pressure this plug must be made of a rigid material.

The snowflake of FIG. 25 is a centric plug with two rows of arches.

FIG. 26 gives a cross section of a centric plug with an elaborated internal structure, where 1 is the plug, 2 is a fissure to split the plug in two or four parts and 3 is a thin bridge to keep the four parts of the plug together. The bridge breaks easier than that the parabolas will compress. The figure is plain, two-dimensional. The internal structure given here is based on parabolas providing a maximum construction strength in case the central part of the plug collapses under the pressure of an inserted device. The benefit of such a construction is that the plug is fit for a thin nail or screw and also for a thick one. This type of plug allows a maximum flexibility in respect to the diameter of the nail or screw inserted. Given a bore where the plug fits in well, the plug is a little compressed centrally using a thin nail. The internal construction around gives enough strength to clamp the nail. Using a thick nail almost as broad as the bore, the plug is compressed almost entirely. The internal construction with its cavities gives enough room for maximum compression. Thus with such a construction one type of plug is fit for nails or screws with a variety of thicknesses.

An Optimal Design

An example of an optimal design is given. See FIGS. 1 and 2 for a 3D picture of this design. Using this plug, the device to be inserted is placed next to this solid plug. FIG. 3 gives an example of optimum sizes for a cross section of the plug. This plug is fit to be inserted in bores of 3 mm diameter and wider, as shown in FIG. 4. The length of the plug is about 2 cm. The given size and shape are chosen because of the following reasons:
To use the said arch-construction, resulting in a strong compression and a strong counter pressure using not much material. In this design, the plug has no internal cavities. The cavity needed for compression is made by the protrusions adjacent to the wall of the bore, the protrusions together with the ‘body’ of the plug forming an arch.
To give a hollow to let ‘land’ the inserted device, the hollow being the long shallow side of the plug.
To make the plug most universal in respect to a variety of bore diameters and a variety of nail diameters, starting from the minimum stone drill size in common DIY (do-it-yourself) stores being 3 mm diameter and starting from the minimum nail size of 1 mm diameter. So you need only one plug size in combination with the common stone drill measures of 3, 4, 5 mm etcetera; one plug for a bore of 3 mm; one or two plugs for a bore of 4 mm; one, two or three plugs for a bore of 5 mm etc. FIG. 4 shows how one plug size is sufficient to fill bores drilled with the standard available drill sets of 3 mm, 4 mm, 5 mm and 6 mm
To give maximum ease of use by the symmetry of the plug.

How it Works

FIG. 5 gives an example of how a single plug is used. Plug 1 is inserted in bore 2. Nail 3 is inserted and driven into the bore. The nail presses itself in the plug giving a strong fixation between plug and nail, and between the plug and the outer side of the bore.

There are three surfaces where clamping is necessary:

1. The surface between plug and the wall of the bore.
2. The surface between plug and inserted device.
3. When using more than one plug: the surface(s) between two plugs.

Because the surface between plug and nail is the most critical one in respect to clamping, the following description of the dynamics of the plug in contact with the inserted device is focused on the ‘nail’ situation.

Basic is the arch construction. See FIG. 6 for the implicit arch in the said plug of FIGS. 1, 2, 3 and 4. In bore 1 the plug 2 is clamped by nail 3 which exerts clamping forces on the plug. The forces from the inserted nail and the corresponding counter pressures are indicated with double-headed arrows like arrow 4. In the picture the plug is almost not deformed; the black circle 3 indicates the tip of the nail, whereby the nail is in the starting phase of the clamping process. In this phase the virtual arch formed by the arrows that indicate the average forces has the shape of a triangle because the pressure of the nail is exerted from one contact point between nail and plug. Proceeding the clamping process, The tip of the nail is inserted further inside which is shown in FIG. 7 where the nail is drawn as a bigger circle because the tip of the nail is inserted further. The plug has been deformed leaving a lower arch. In this phase the virtual arch formed by the arrows that indicate the average forces tend to get the shape of a parabola because the pressure of the nail is exerted from many points around the arch. For the given bore diameters of FIGS. 6 and 7 the result of using the arch construction is an optimum between flexibility in nail diameter versus sufficient pressure between plug and nail.

The dynamics of the plug in contact with the wall of the bore are as follows.

1. When the nail (or other device) is inserted, the nail gives its pressure to the plug which gives this pressure to the wall of the bore. Where the plug is in contact with the wall of the bore, the plug material is deformed elastically. Initially the contact points between plug and wall will be the ‘feet’ of the said arch construction.
2. When the pressure becomes too high for elastic deformation, the plug material will be deformed plastically.
3. When the structure of the matrix in which the bore has been drilled is rough on a macroscopic level, the relative softness of the plug material results in the plug surface following the rough wall of the bore, preventing the plug from slipping out of the bore. Normally in a do-it-yourself situation the bore is drilled in some kind of stony material, what implies that the wall of the bore is rough.
4. When the wall of the bore is smooth on a macroscopic level, the plug must give enough pressure to the wall of the bore and the wall must have a sufficient rough surface on a microscopic or molecular level to give sufficient adhesion to prevent the plug from slipping out of the bore. Giving maximum pressure to the wall of the bore is realized by a minimum contact surface between the plug and the wall of the bore, which is realized by protrusions on the plug instead of a larger contact surface. The said arch construction automatically yields a minimum contact surface with the wall of the bore, the said protrusions in contact with the wall of the bore being the ‘feet’ of the arch or arches. See FIGS. 9, 14 and 15 for more arch shaped plugs (cross sections) having their ‘feet’ on the bore wall, in addition to the design given in FIGS. 6 and 7.

Production

The plug designs given here are based on extrusion (e.g. aluminium or plastic extrusion) and pulltrusion (e.g. in case of glassfiber or aramid). This results in designs that only vary in the two cross section dimensions. There are no shape variations in the third (length) dimension except for the length itself, for deformations at the end parts of the plug as a result of separating the plug from an extrusion or pulltrusion profile, for the results of eventually special processing actions on the extrusion profile and for the possibility of delivering the plugs on a rod or role by incomplete separation.

Instead of by extrusion or pulltrusion the plug can be produced by injection moulding. Some features of the plugs described here, such as internal cavities, are not or difficult to realize with injection moulding. In the contrary differentiation within the length dimension, for instance knobs or a tapered shape of the two ends or of one end of the plug, becomes easily to realize with injection moulding.

Advantages Compared with Existing Plugs

Advantages compared with classical nylon plugs using nails:

1. At the moment there are no or almost no plugs for the common kind of nails. Closest to a plug for nails is a little piece of wood or a soft metal rod like thick copper wire. But wood is too soft to give a strong fixation, and both alternatives are not designed in a way which gives optimal strength, an optimal capability for compression and an optimal shape to place more plugs next to each other in one bore. Fischer has quite big nails (10 cm length) in its assortment which are especially designed to fit in a special nylon plug. The new plug described here is designed for common, smooth nails, not for especially designed nails like those of Fischer.
2. Especially for very small nails or screws there are no plugs available. The plug described in FIGS. 3 and 4 is perfectly fit for nails, as well big ones as the smallest ones. The smallest common nails have a diameter of 1 mm. Such a nail can be fixed by the plug given in FIG. 3 in a bore of 3 mm. This small plug is also fit to fix thicker nails and to deal with larger bores, eventually using more plugs in one bore.
3. The new plug described here is not only fit for nails and screws, but also for bolts, for dowels of which the bore is too wide and for several other applications which require some small clamping device. As an example I have fixed a metal arm in a soft stone wall carrying a television screen, using prototype plugs of 3 mm×1 mm in cross section to fix three thick bolts.

Advantages Compared with Classical Nylon Plugs using Screws:

1. The plug described here needs a borehole that is only as wide or slightly wider than the thickness of the screw. The bore in the case of the classical plug is remarkably wider than the screw itself and therefore causes more damage to the wall. Especially in bathroom or kitchen walls with tiles drilling narrow bores is an important feature; the chance of damage to tiles is reduced by drilling in the (narrow) space between the tiles. When drilling through a tile is necessary, the chance of damage is reduced using a narrow drill instead of a thick one.
2. Because of the narrow bore, working with the new plug is easier than working with a classical plug. It takes less effort to drill a narrow bore than a wider one.
3. In classical plugs the width of the bore must exactly match with the outer size of the plug. In the plug described here the diameter is less critical; the plug can be much smaller than the bore and the bore can be much wider than the screw.

Therefore the new plug gives much more freedom in the choice of the drill measure and of the diameter of the screw. This freedom is augmented by the possibility to use more than one plug in a bore. The plug can be designed in such a way that the plugs are placed neatly next to each other giving a strong basis for fixation of the screw, see FIG. 4.

4. A common problem with doors, mounted by screws which are driven into wood, is that the quality of fixation reduces after years. To fix the screw again, one can use the new plug. The new plug will give stability to the screw which was moving in its hole. A classical nylon plug is not ideal for this application because this is a centric plug with a rather smooth outer surface. The nylon plug easily will slip out of the wood.
5. For very large screws there are no classical nylon plugs available in the common DIY stores. It appears that one tiny new plug can fix a big screw in a soft stone wall to mount an arm carrying a television.

Advantages in General:

1. An advantage occurs in mounting something like a piece of gypsum board to a wall. In the classical situation first a bore must be drilled in the wall to make a hole for the plug to insert. A hole with a smaller diameter must be drilled in the gypsum board. This is elaborate and it can cause quite a problem because the holes in the wall must be drilled exactly in place compared with the holes in the gypsum board. Using the new plug you only need one drill action to drill simultaneously through the gypsum board and in the wall.
2. Because the diameter of the bore is not as critical as with the conventional plug, you do not need a complete range of drills.
3. Because the diameter of the plug is less critical and more than one plug can be used in one bore, you only need one plug size, not a whole range of plugs in stock. This reduces the amount and complexity of plugs in stock and reduces the logistic complexity in all links of the supply chain.
4. A metal plug, compared with a nylon plug, is better fit for very hot conditions.
5. In many of the given plug designs the device is inserted eccentric in respect to the bore. This seems to be a disadvantage because the user cannot fix the device precisely in the middle of the bore. On the contrary this is an advantage because, especially in a stony matrix, the bore often is not exactly in place. With the new plugs, the user has the possibility to choose different positions to insert the device, as shown in FIG. 27.

Benefits using a Dowel:

1. When a dowel is somewhat too narrow for the bore, the plug described here can be used to give the clamp effect needed.

Benefits using a Bolt:

1. When a bolt is too narrow for the nut, the plug described here can be used to give the fixation needed.
2. In a situation where a bolt is fixed in a bore using mortar, composite mortar or glue a problem can be that this method does not give instant fixation. The plug described here can give this instant fixation while the mortar, composite mortar or glue is hardening. See also conclusion 7.
3. Using the new plug, a bolt can be screwed in a bore, which results in a strong fixation of the bolt. In classical plugs this will not give good results in most cases because of the discrete diameter of the plug needed, the lack of clamping because the thread of a bolt bites less deep in the plug material than the thread of a screw, the absence of the possibility to arrange several plugs in one bore and the lack of compression capability keeping sufficient lateral counter pressure to clamp the bolt.

1-19. (canceled)

20. A plug for clamping a device in a bore, said plug having a length and a cross section and substantially no shape variations along the length, said cross section comprising at least one arch.

21. The plug of claim 20 having a hollow in which the device can land.

22. The plug of claim 21 wherein the hollow is positioned at the top of an arch.

23. The plug of claim 20 comprising, in cross section, a plurality of arches.

24. The plug of claim 23 wherein the plurality of arches form cells.

25. The plug of claim 20 wherein the device is a nail, a screw, or a dowel.

26. The plug of claim 20 which is made by extrusion, pulltrusion, or injection molding, preferably by extrusion.

27. The plug of claim 20 comprising a metal selected from the group consisting of aluminum, copper, zinc, magnesium, gold, and alloys thereof.

28. The plug of claim 27 comprising an alloy of zinc, aluminum, magnesium and copper.

29. The plug of claim 20 comprising a plastic, optionally also comprising twisted fibers.

30. The plug of claim 29 wherein the twisted fibers comprise carbon fiber, glass fiber, aramid fiber, or vegetable fiber such as hemp.

31. The plug of claim 20 comprising at least one cavity containing an adhesive.

32. The plug of claim 31 comprising a first component of an adhesive in a first cavity, and a second component of the adhesive in a second cavity, whereby the second cavity is in the same plug as the first cavity or in a different plug.

33. The plug of claim 20 having the general shape of a bone.

34. The plug of claim 20 having two ends, said plug being deformed, for example tapered, at at least one of the ends.

35. The plug of claim 26 comprising a metal selected from the group consisting of aluminum, copper, zinc, magnesium, gold, and alloys thereof.
